(19) United States
(12) Patent Application Publication
(10) Pub. No.: US 2006/0084300 A1
(43) Pub. Date: Apr. 20, 2006

(54) Magnetic construction kit adapted for use with construction blocks

(76) Inventors: Charles J. Kowalski, Ridgewood, NJ (US); Lawrence I. Rosen, Mendham, NJ (US); Parviz Daftari, Summit, NJ (US)

Correspondence Address: MICHAEL BEDNAREK;PILLSBURY WINTHROP SHAW PITTMAN LLP, 1650 TYSONS BLVD., MCLEAN, VA, 22102, US

(21) Appl. No.: 11/249,373

(22) Filed: Oct. 14, 2005

Related U.S. Application Data
(60) Provisional application No. 60/619,277, filed on Oct. 15, 2004.

(51) Int. Cl. H01R 4/66

(52) U.S. Cl. 439/100

(57) ABSTRACT

A magnetic construction kit is provided for connecting base blocks with a variety of connecting rods. The construction kit includes a base block and a connecting rod having at least one magnetic connector suitable for cooperating with another magnet and/or for holding a spherical object. A stud connector can be included for attachment of the connecting rod to a stud of the base block. The stud connector may mechanically connect onto a stud extending from an exposed surface of the base block. Alternatively, the stud and stud connector may also have a magnetic attachment by providing a magnet in the stud connector and providing a stud made of, or coated with, a ferromagnetic material. The construction kit may also include different connecting rod structures that are suitable for achieving mechanical and/or magnetic connections to different sized base blocks.

This application claims the benefit of U.S. Provisional Application No. 60/619,277, filed Oct. 15, 2004, which is herein incorporated by reference in its entirety.

### BACKGROUND

1. Field of the Invention

The present disclosure is directed generally to puzzles and toys. More particularly, the present disclosure is directed to a construction kit suitable for cooperating with conventional block-type construction elements, and even more particularly to a magnetic construction kit suitable for providing conventional block-type construction elements with magnetic connecting capability.

2. Background of the Invention

Individuals often find enjoyment in the challenge of building aesthetic structural designs and/or functional structural models. Frequently, the utility associated with constructing such structural models is found in the creative and/or problem solving process required to achieve a desired structural objective. Over the years, various construction or building sets have been introduced to the market and utilized by individuals to create a variety of different structural profiles. One drawback associated with traditional building sets is that their various construction elements (e.g., building blocks having coupling studs and corresponding tubular couplings) tend to be limited in type. Another drawback is found in that although the construction elements have predefined geometries in order to provide suitably stable or secure interconnections between corresponding parts, the predefined geometries also tend to inhibit the design/construction flexibility provided by these known building sets.

Accordingly, as a substantial inventory of base blocks can be accumulated by individuals attempting to improve design/construction flexibility, there is a need for an adaptive magnetic construction kit that is suitable to cooperate with known construction elements and thereby provide greater construction flexibility and/or design choice.

### BRIEF SUMMARY OF THE INVENTION

In accordance with an exemplary embodiment of the present invention, a magnetic construction kit is provided that permits improved structural profiles and increased construction flexibility and/or design choice. More particularly, the kit of the present invention includes a connecting rod having at least one magnetic connector suitable for cooperating with another magnet or for holding a ferromagnetic object. Optionally, the connecting rod may include a mechanical connector suitable for engaging a coupling stud or other like structure operatively associated with a base block. Thus, the present invention provides increased design/construction flexibility and sophistication by allowing conventional mechanically connected elements to have an additional magnetic connection capability.

According to an advantageous feature of the present invention, the connecting rod may be a composite member where the magnetic connector and/or the mechanical connector are separable from a main body so as to be interchangeable and/or replaceable. Another advantageous feature of the invention involves magnets and/or magnetically structures being directly associated with the base block so as to provide for a variety of different magnetic connections.

According to yet another advantageous feature of the present invention, the magnetic and/or mechanical connectors of the connecting rod are sized and shaped to mechanically connect to the base block in different ways. Furthermore, the connecting rod can have a number of magnetic and/or mechanical connectors suitable for engaging the base block in a many different ways, so as to provide additional structural design/construction alternatives.

Other aspects, features and advantages of the present invention will be readily apparent from the following detailed description.

### BRIEF DESCRIPTION OF THE DRAWINGS

For a better understanding of the present invention, reference is made to the following detailed description of various exemplary embodiments thereof, considered in conjunction with the accompanying drawings, in which:

FIG. 1A is a perspective view of a pair of connecting rods and a base block according to an exemplary embodiment of the present invention;

FIG. 1B is a side, cross-sectional view of the base block and one of the connecting rods of FIG. 1A, demonstrating an illustrative mechanical connecting arrangement;

FIG. 2A is a perspective view of a pair of connecting rods and a base block according to another exemplary embodiment of the present invention;

FIG. 2B is a side, cross-sectional view of the connecting rods and base block of FIG. 2A, demonstrating alternative connecting arrangements;

FIG. 3A is a perspective view of a ferromagnetic structure for use with a base block according to another illustrative aspect of the present invention;

FIG. 3B is an exploded cross-sectional view of the ferromagnetic structure of FIG. 3A, demonstrating alternative connecting arrangements;

FIG. 4A is a perspective view of a ferromagnetic structure for use with a base block according to still another illustrative embodiment of the present invention;

FIG. 4B is an exploded cross-sectional view of the ferromagnetic structure of FIG. 4A, demonstrating yet another exemplary connecting arrangement;

FIG. 5A is a perspective view of a modified base block according to an alternative embodiment of the present invention;

FIG. 5B is a side, cross-sectional view of the modified base block of FIG. 5A, shown with a pair of connecting rods;

FIG. 6A is a perspective view of an alternative connecting arrangement according to an illustrative embodiment of the present invention;

FIG. 6B is a side, cross-sectional view of the connection arrangement of FIG. 6A;

FIG. 7 is a cross-sectional view of a connecting rod and base block according to a further alternative embodiment of the present invention;

FIG. 8 is a cross-sectional view of a connecting rod and base block in accordance with still another alternative embodiment of the present invention;

FIG. 9 is a perspective view of a base block according to a still further embodiment of the present invention;

FIG. 10 is a cross-sectional view, taken along section line 10-10 and looking in the direction of the arrows, of the base block illustrated in FIG. 9;

FIG. 11 is a cross-sectional view, taken along section line 11-11 and looking in the direction of the arrows, of a portion of the base block illustrated in FIGS. 9 and 10;

FIG. 12 is a cross-sectional view of a construction kit according to an alternative embodiment of the present invention; and

FIG. 13 is a plan view of two building blocks placed side-by-side according to a further embodiment of the present invention.

### DETAILED DESCRIPTION OF THE INVENTION

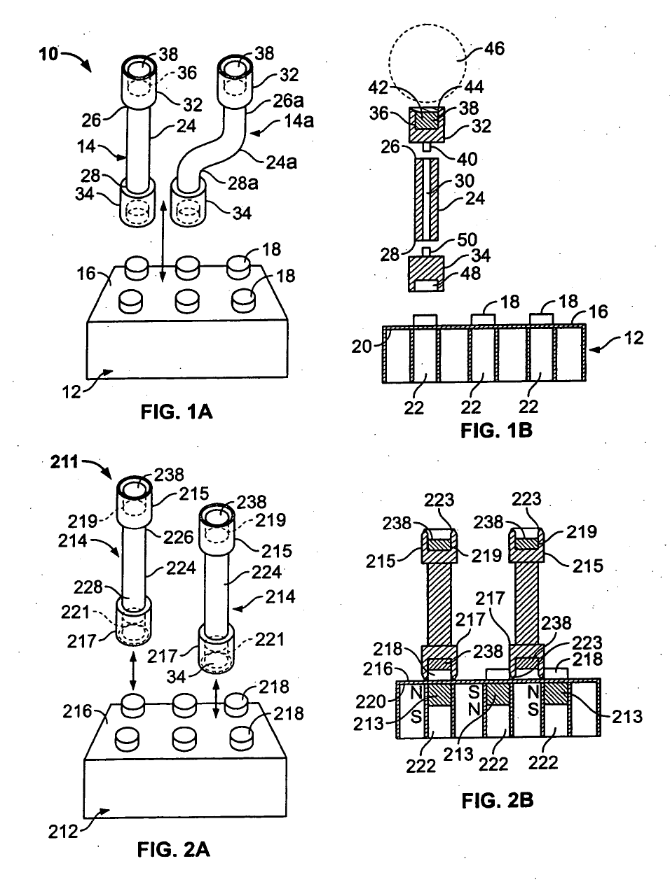

FIGS. 1A and 1B depict an exemplary embodiment of a construction kit 10 according to the present invention. The kit 10 includes a base block 12 and connecting blocks or rods 14, 14a, each of which is adapted to be connected to the base block 12. Base block 12 is made of injection molded plastic, for example.

As shown in FIG. 1A, the base block 12 has an upper surface 16 with one or more coupling studs 18 arranged thereon. The coupling studs 18 are normally spaced apart from each other and project in a substantially perpendicular direction relative to the upper surface 16. While the coupling studs 18 shown in FIG. 1A are cylindrical, an artisan understands that any desired geometric shape can be used. The number of coupling studs 18 provided on the upper surface 16 can be varied according, for example, to the amount of coupling studs 18 needed, area of the upper surface 16, and/or the size of the studs. In an alternative exemplary embodiment (not shown), an upper surface 16 of base block 12 contains one coupling stud 18, which is formed as a thin, locating pin.

FIG. 1B provides a cross-sectional view of the base block 12 that shows an opposing inner surface 20 on the underside of upper surface 16. Several coupling channels 22 project from the opposing inner surface 20 with the interior of the base block 12 in a direction opposite to that of the coupling studs 18. The coupling studs 18 and coupling channels 22 are preferably axially aligned and sized so as to permit stacking of two or more base blocks 12. The number of coupling channels 22 arranged within an interior of a given base block 12 is dependent on a number of factors, such as the particular size and shape of the base block 12, size of the channels 22, and the size and shape of the studs 18. For example, coupling channels 22 can be sized for securely retaining (e.g., frictionally mated) complementary coupling studs 18 associated with another base block element 12, where the studs are positioned within or in between the coupling channels.

In an alternative embodiment (not shown), a lower surface of base block 12 is a flat surface without coupling channels 22.

With continued reference to FIGS. 1A and 1B, the connecting rod 14 has an elongated body 24 with ends 26, 28. The ends 26, 28 of the body 24 can be axially aligned. However, as shown in FIG. 1A, a body 24a, which is generally Z-shaped without axial alignment at its ends 26a, 28a, can also be used as the body 24a of the connecting rod 14a. In fact, the generally Z-shaped body 24a may assist a user in connecting to any size of a base block that is desired.

Referring to FIG. 1B, the body 24 also has a recess 30 formed in an axial direction. The recess 30 is used to attach magnetic connector 32 and stud connector 34, respectively, to the ends 26, 28 of the body 24, thus forming the connecting rod 14 shown in FIG. 1A.

With regard to the magnetic connector 32, it is noted that the pocket 36 can be formed such that the magnet 38 can be fixedly retained therein by any method known in the art suitable for accomplishing such an operation (e.g., friction-fit, adhesive, or snap-fit). It is also noted that the magnet 38 may be positioned within the pocket 36 so that an exposed surface 42 of the magnet 38 has a desired polarity, i.e., north (N) or south (S). An edge 44 of the pocket 36, which is preferably beveled, assists in retaining the magnet 38 within the magnetic connector 32. The exposed surface 42 can provide a magnetic attachment to an object, such as spherical object 46. The edge 44 assists in providing a mechanical connection to the spherical object 46 in addition to the magnetic attachment, particularly if the edge is beveled at an angle that follows a contour of the spherical object 46.

With regard to the stud connector 34, a cavity 48 is defined therein at one end and a shank 50 extends from an opposite end. The cavity 48 is sized to receive and accommodate one of the coupling studs 18 of the base block 12, so as to enable the connecting rod 14 and the base block 12 to be operatively connected as desired to effectuate different structural profiles. The size of the cavity 48 should correspond to a size of the coupling studs 18 so as to permit a releasable connection by, for example, a friction-fit connection. Other connection types may be used depending on the geometric constraints associated with the base block 12. The shank 50 extends from an end of the stud connector 34 and is adapted for male-female complementary engagement by arranging the shank 50 of the stud connector 34 into the recess 30 of the body 24 at the end 28.

While it is preferred that the connecting rod 14 is a composite member having both a magnetic connector 32 and a stud connector 34 being releasably connectable thereto, it may be desirable for either (or both) the magnetic connector 32 and the stud connector 34 to be permanently attached to the body 24 of the connecting rod 14. As will be evident to those skilled in the pertinent art from the present disclosure, various construction elements may be provided to magnetically connect the magnetic connector 32 to the body 24 of the connecting rod 14. In addition, the skilled artisan will recognize that the features described above for connecting rod 14 could apply similar to connecting rod 14a or any other shaped rod.

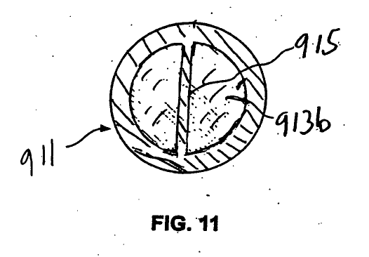

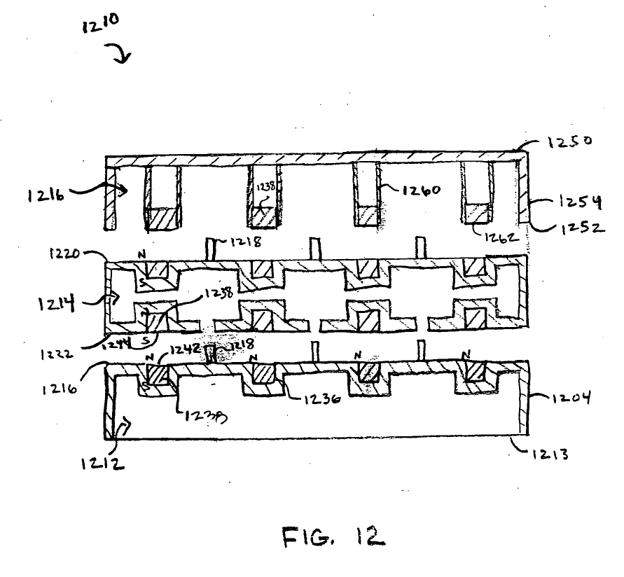

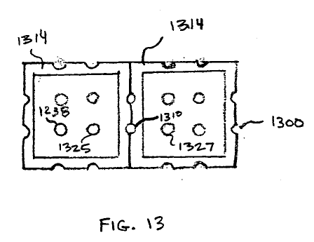

Another exemplary embodiment of the present invention is shown in FIGS. 2A and 2B. Elements illustrated in FIGS. 2A-11, which correspond to elements described above with reference to FIGS. 1A and 1B, are increased by two hundred. In addition, elements that do not correspond to elements described with reference to FIGS. 1A and 1B are designated as odd numbered reference numerals. The embodiments to be shown and described operate in the same manner and provide the same advantages, unless otherwise noted.

As shown in FIGS. 2A and 2B, a construction kit 211 having a base block 212 and two connecting rods 214 is provided directly with one or more discrete channel magnets 213 (shown in FIG. 2B) arranged within some of the channels 222. As shown, each channel magnet 213 is sized and shaped so as to be inserted, preferably permanently, into the coupling channels 222 of the base block 212. Each coupling channel 222 and its corresponding channel magnet 213 can be cylindrical, rectangular, or have some other shape determined by the predefined mechanical connecting characteristics associated with the base block 212. In an alternative aspect of the present invention, the channel magnets 213 can be releasably connected with the coupling channels 222 as needed in order to effectuate different connecting arrangements.

With further reference to FIGS. 2A and 2B, magnetic connectors 215, 217 respectively replace the magnetic connector 32 and the stud connector 34 used in the connecting rods 14, 14a shown in FIGS. 1A and 1B. The magnetic connectors 215, 217 are releasably connected at opposite ends 226, 228 of the body 224, as shown in FIGS. 2A and 2B.

As shown in FIG. 2B, with regard to the magnetic connectors 215, 217, it is noted that connector 215 has a pocket 219 and connector 217 has a pocket 221, each of which respectively retains a magnet 238 in a substantially recessed manner. Each of the magnetic connectors 215, 217 has an edge 223 formed at the furthermost portion of the pocket. In the case of magnetic connector 217, this edge 223 is adapted to connect mechanically to one of the coupling studs 218. The edge 223 preferably conforms to the surface contour of the coupling stud 218 so as to at least somewhat physically grip the coupling stud 218. In the case of the magnetic connector 215, the edge can be adapted to grip a particular object, such as a magnet protruding from another object (not shown).

With continuing reference to FIG. 2B, the channel magnets 213 are disposed within the coupling channels 222 so as to be adjacent the coupling studs 218. Further, the channel magnets 213 are preferably oriented with respect to the corresponding coupling channels 222 so that the polarities (i.e., N for north and S for south) associated with adjacent coupling studs 218 are different relative to one another. This arrangement beneficially maximizes the magnetic flux directed through, about and between the coupling studs 218 and the second magnetic connector 217, thus providing for a magnetic connection, in addition to a mechanical connection, between the connecting rod 214 and the base block 212.

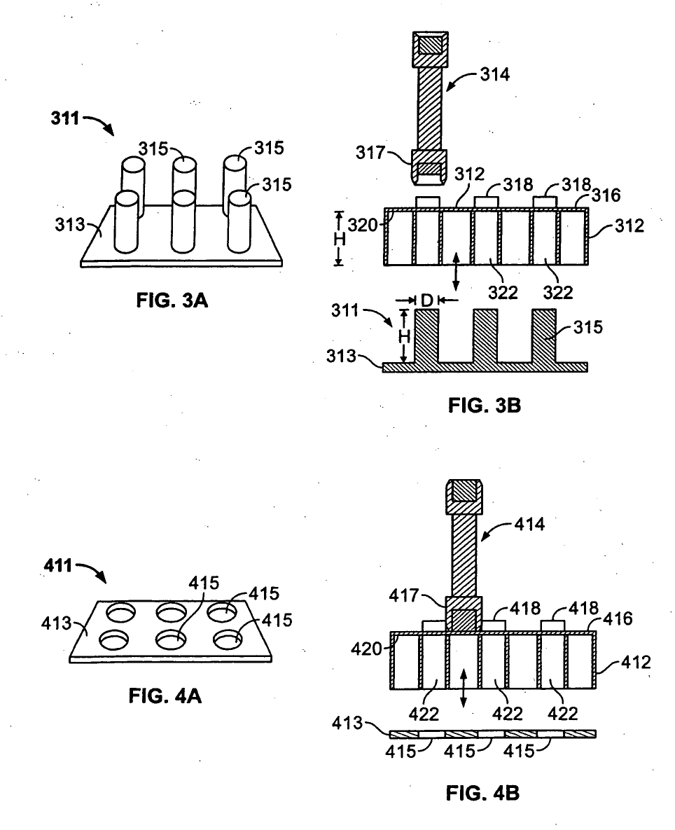

Referring to FIGS. 3A and 3B, in another aspect of the present invention, a ferromagnetic structure 311 is operatively connected to the base block 312 (shown in FIG. 3A) for generating a magnetic flux between, for example, the base block 312 and the connecting rod 314. This ferromagnetic structure 311 provides both a mechanical and magnetic connection for the connecting rod 314 and the base block 312. The ferromagnetic structure 311, as shown, includes a plate 313 having a number of shanks 315 projecting therefrom. The dimensions (e.g., height “H” and diameter “D”) of the shanks 315 are preferably coincidental with the coupling channels 322 of the base block 312 so as to snuggly fit therein. Further, the shanks 315 are preferably disposed within the coupling channels 322 so as to be adjacent the respective coupling studs 318 and thereby beneficially maximize the magnetic flux directed through and about the coupling studs 318 when, for example, the magnetic connector 317 of the connecting rod 314 is in close proximity thereto. Thus, connecting rod 314 can be magnetically connected to the base block 312 so as to allow for additional magnetic elements to be added and thereby define a variety of different structural profiles.

Still another exemplary embodiment of the invention is shown in FIGS. 4A and 4B, wherein there is shown a ferromagnetic structure 411 shaped in the form of a plate 413. Unlike the system of shanks 315 shown in FIGS. 3A and 3B, the plate 413 has a number of apertures 415 arranged therein. The apertures 415 are sized and shaped to fit between the coupling channels 422 so as to allow the plate 413 to be frictionally retained in the base block 412 via the coupling channels 422. The plate 413 is preferably positioned within the base block 412 so as to be adjacent inner surface 420 thereof. This arrangement maximizes the magnetic flux directed through and about the surfaces 416, 420 of the base block 412 when, for example, the magnetic connector 417 is in close proximity thereto. In addition, the magnetic connector 417 can be made from a ferromagnetic material so as to further enhance the magnetic attraction between the connecting rod 414 and the base block 412.

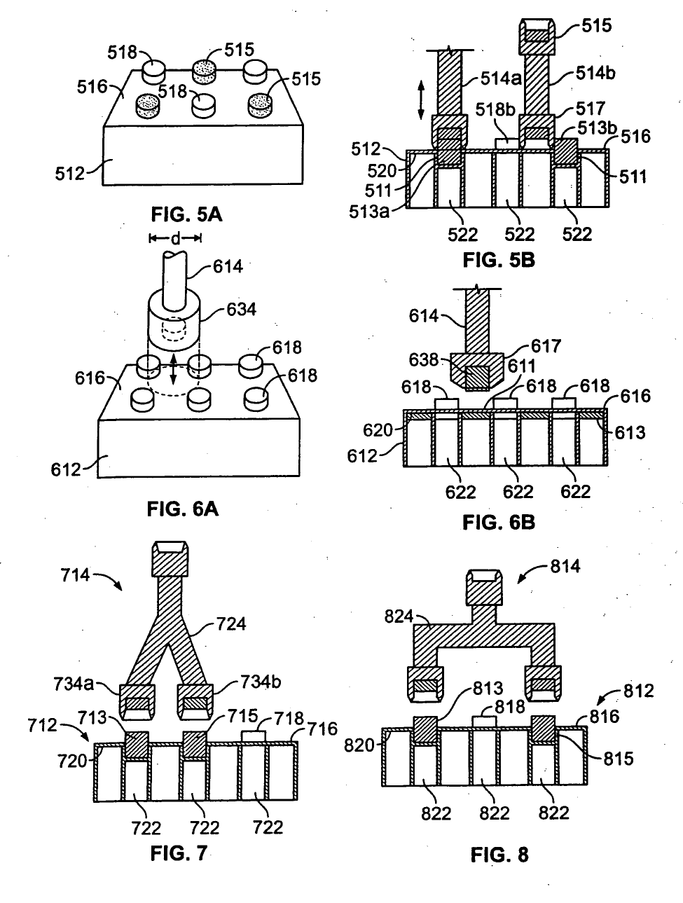

In the exemplary embodiment shown in FIGS. 5A and 5B, the base block 512 has been modified to provide for different magnetic and/or mechanical connections between the base block 512 and the connecting rods 514a and 514b. The base block 512 has at least one exposed surface 516 with one or more recesses 511 for securely holding, preferably in a permanent manner, a corresponding number of stud magnets 513a, 513b. The stud magnets 513a, 513b preferably project upward from the recesses 511. Thus, the connecting rod 514a has a direct magnetic attachment to magnet 513a. Alternatively, the connecting rod 514b has a mechanical attachment to stud 518b. From the opposed inner surface 520 of the base block 512, there are coupling channels 522 that extend directly away from inner surface 520 of the base block 512. The number of recesses 511 and coupling channels 522 provided is dependent on the particular size and shape of the base block. The recesses 511 can be intermittently arranged so as to cooperate with any of a number of different types of studs (e.g., mechanical and magnetic) to permit a variety of magnetic and/or mechanical connections. The variety of connection provides flexibility in that a number of such elements can be selectively interconnected to thereby define a composite structural profile.

FIGS. 6A and 6B illustrate some of the ways according to the present invention that a connecting rod can be attached to a base block. For example, as shown in FIG. 6A, the connecting rod 614 is attached to the base block 612 by positioning a stud connector 634 between a group of coupling studs 618. In this example, the stud connector 634 has an outer diameter “d” suitable to interact with at least two (2), and preferably four (4), coupling studs 618 so as to be frictionally retained thereby. Other connections may also be achieved depending on the geometric constraints associated with the base block 612. It is also possible that a magnetic connector (not shown) is sized to have a diameter that can be positioned relative to the studs 618 in a fashion similar to the stud connector 634.

As shown in FIG. 6B, the connecting rod 614 can be modified such that the magnet 638 extends outward from the magnetic connector 617 so as to make direct contact with an exposed surface 611 of the base block 612 when the connecting rod 614 is engaged therewith. The extent to which the magnet 638 extends from the magnetic connector 617 may be varied as needed. The amount that the magnet should extend depends upon the geometry of the base block 612 so as to magnetically cooperate with a ferromagnetic structure 613 arranged on the inner surface 620 of the base block 622.

FIGS. 7 and 8 illustrate some alternative configurations of the present invention. Both the shape of the connecting rods 724, 824 and the arrangement of magnetic coupling studs 713, 715, 813, 815 in the respective base blocks provides a user with additional flexibility in construction.

For example, FIG. 7 shows that the body 724 is Y-shaped and has stud connectors 734a and 734b attached to both appendages. In this example, the connecting rod 714 can be simultaneously connected with two directly adjacent magnetic coupling studs 713, 715 that are arranged on the base block 712.

FIG. 8 illustrates another alternative configuration, wherein the body 824 has a rectangular “U” shape. This U-shape can be used to permit the connecting rod 814 to be simultaneously connected to two distanced magnetic coupling studs 813, 815 arranged on the base block 812. In addition, the connecting rod 824 can be formed in any desired shape, including but not limited to being H-shaped, T-shaped, X-shaped, Z-shaped, or any other shape according to desire or need.

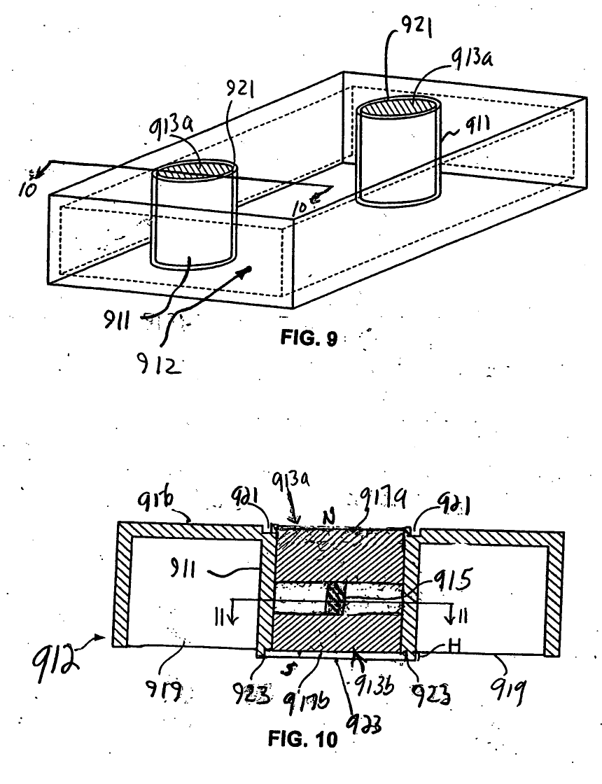

FIGS. 9-11 illustrate another embodiment of the present invention, which utilizes a pair of cylindrical wells 911 arranged within a base block 912. Magnets 913a, 913b are arranged within each of the wells 911 by, for example, a friction fit. A rib 915, which extends diametrically across a midsection of each of the wells 911, positions the magnet 913a such that its exposed surface 917a is substantially flush with an upper surface 916 of the base block 912 (see FIG. 10). In a similar manner, the rib 915 positions the magnet 913b such that its exposed surface 917b is substantially flush with a lower surface 919 of the base block 912 (see FIG. 10). It is also noted that the magnets 913a, 913b should be positioned such that their exposed surfaces 917a, 917b have opposite polarities, whereby two identical base blocks 912 can be stacked one on top of the other in a magnetically attracted arrangement. To provide additional stability when stacking identical base blocks 912, the upper surface 916 is provided with annular recesses 921, each of which surrounds a corresponding one of the wells 911. The recesses 921 are sized and shaped so as to releasably mate in a tongue-and-groove fashion with an annular rim 923 projecting downwardly from a corresponding one of the wells 911 on an overlying base block.

FIG. 12 illustrates a cross-sectional view of an alternative embodiment of construction kit 1210 according to the present invention. The kit 1210 includes a base block 1212, building blocks 1214 and finishing blocks 1216. In a preferred embodiment of the present invention, base block 1212, building blocks 1214 and finishing blocks 1216 have various shapes, sizes and colors within a single kit 1210.

Base block 1212 has an upper surface with one or more locating pins 1218 and one or more pockets 1236 arranged thereon. A magnet 1238 may be received in each of the pockets 1230. Locating pins 1218 are normally spaced apart from each other and project in a substantially perpendicular direction relative to the upper surface 1216. While the locating pins 1218 shown in FIG. 12 are formed as pins, an artisan understands that any desired geometric shape or size can also be used. The number of locating pins 1218 provided on the upper surface 1216 can be varied according to the area of the upper surface 1216 or the size of pins 1218, for example.

In a preferred embodiment of the present invention, pocket 1236 is formed such that the magnet 1238 is substantially flush with upper surface 1216. However, in an alternative embodiment of the present invention, the magnet 1238 may protrude from upper surface 1216 or be recessed from upper surface 1216. Magnet 1238 can be fixedly retained therein by any method known in the art suitable for accomplishing such an operation (e.g., friction-fit, adhesive or snap-fit).

In addition, magnet 1238 is positioned within the pocket 1236 so that an exposed surface 1242 of the magnet 1238 has a desired polarity, i.e., north (N) or south (S). In the example shown in FIG. 12, each magnet 1238 of base block 1212 is arranged so that exposed surface 1242 is the N pole. However, an artisan will recognize that any configuration can be used. For example, magnets 1238 of base block 1212 can be arranged so that exposed surfaces 1242 are all the S pole or any combination of N and S poles.

A lower surface 1213 of base block 1212 is shown as a smooth, flat surface. Although lower surface 1213 is not depicted with any magnets, in an alternative embodiment of the present invention, magnets may be provided such that base block 1212 is stackable with magnetic attraction through lower surfaces. The bottom surface may be formed with locating holes to accommodate locating pins 1218. In an alternative embodiment, magnets are disposed in cylinders suspended from upper surface 1216 with open channels between the magnets and no bottom surface at the open channels. One of ordinary skill in the art also will recognize that a lower surface 1213 may be open without magnets, such that sidewalls, rather than lower surface 1213, support base block 1212.

Building block 1214 has an upper surface 1220 and a lower surface 1222. Building block 1214 is configured for stacking onto base block 1212 and other building blocks 1214. Upper surface 1220 of building block 1214 has a similar arrangement to upper surface 1216 of base block 1212. That is, upper surface 1220 is arranged to have one or more locating pins 1218 and one or more pockets 1236 with magnets 1238 arranged therein to lie substantially flush with upper surface 1220. In a preferred embodiment, the configuration of locating pins 1218 and magnets 1238 (including their polarity arrangement) axially aligns and matches that of upper surface 1216. Thus, upper surface 1220 of building block 1214 would not connect with upper surface 1216 of base block 1212 or to the upper surface 1220 of another building block 1214, because the aligning magnets would magnetically repel due to the polarity of each surface being the same and because the locating pins on each surface would prevent a fit between the surfaces 1220, 1216 or the surfaces 1220, 1220.

However, lower surface 1222 of building block 1214 would stack onto an upper surface 1216 of base block 1212 or onto an upper surface 1220 of another building block 1214. Notably, lower surface 1222 contains one or more locating holes 1224 arranged thereon and one or more pockets 1236 for accommodating magnets 1238 as described above. Magnets 1238 of lower surface 1222 are positioned such that their exposed surfaces 1244 have opposite polarities to the aligning, exposed surface 1242 of the magnets 1238 of upper surface 1216 or 1220, whereby two identical building blocks 1214 can be stacked one on top of the other or on top of base block 1212 in a magnetically attracted arrangement.

Locating holes 1220 receive locating pins 1218 to perfect alignment of the blocks and provide additional stability. Thus, it will be appreciated that the combination of axially aligning magnets with attracting polarities and the cooperation of locating pins and locating holes enables quick, precise positioning of the building blocks 1214. Although locating holes 1220 are shown as holes in a surface, one of ordinary skill in the art will recognize that a pocket or recess may be formed in a lower surface to accommodate locating pin 1218 in lieu of locating holes.

Finishing block 1216 may be used as a top to a structure or construction. For example, finishing block 1216 may represent a type of roof in a kit 1210. Thus, no exposed magnetic surface appears at an upper surface 1250 of finishing block 1216.

In one preferred embodiment, a tube 1260 is formed with a magnet 1238 fit at the end of the tube. Tube 1260 extends from a bottom of upper surface 1250 to a point such that an exposed surface 1262 of the magnet substantially aligns with a bottom surface 1252 of sidewall 1254. The magnet 1238 may be fit by any suitable means.

In another embodiment, rather than forming tubes 1260 from an upper surface 1250, a lower surface (not shown) is formed in a similar manner to the lower surface of building block 1214 (e.g., with locating pin holes and pockets for fitting magnets).

In another embodiment, thin ferromagnetic plates (e.g., metal discs) are used in place of some of the magnets shown in FIG. 12. In one example, in finishing block 1216, ferromagnetic discs replace all magnets 1238, while in building block 1214 and base block 1212 ferromagnetic discs replace only the magnets 1238 located between the two end magnets 1238. The skilled artisan will appreciate that any combination of ferromagnetic discs and magnets can be used in base block 1212, building block 1214 and finishing block 1216.

FIG. 13 shows a plan view of two building blocks 1314 placed side-by-side. Building blocks 1314 include one or more magnets 1238 as well as one or more notches 1300 in the exterior surfaces of their walls. As shown, notches 1300 can be semicircular in shape. However, other shapes for notches 1300 are within the scope of the present invention. For example, notches 1300 could be shaped as half a square.

When two building blocks 1314 are placed side-by-side, notches 1300 of the adjacent blocks combine to form a hole 1310 for receiving a locating pin. In addition, the magnets adjacent the formed hole 1310 (e.g., magnets 1325 and 1327) can align with magnets or ferromagnetic plates of another block, such as block 1214 of FIG. 12. With block 1214, one of the locating pins 1218 could be positioned within hole 1310. In this manner, blocks of varying sizes can be combined and aligned in various configurations with improved stability and alignment.

Although illustrative embodiments and exemplary aspects of the present disclosure have been described with reference to the schematic illustrations herein, the present disclosure is not limited thereto. Rather, the various structural components and/or assemblies disclosed herein, which have been provided for purposes of illustration and not for limitation, are susceptible to modification and/or variation without departing from the spirit of the present disclosure. Furthermore, it will be understood by those skilled in the pertinent art based on the teachings herein that the above-discussed structural components/features may be operatively connected to form a variety of different construction combinations.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A construction kit, comprising:
a plurality of base blocks, each base block having
an upper surface with at least one pocket fitted with a first magnet having an exposed surface of a first polarity, at least one pocket fitted with a first ferromagnetic disc, and at least one locating pin; and
a plurality of building blocks, each building block having
a lower surface with at least one pocket fitted with a second magnet having an exposed surface of a second polarity that is opposite to the first polarity, at least one pocket fitted with a second ferromagnetic disc, and at least one locating hole for receiving a locating pin, and
an upper surface with at least one pocket fitted with a third magnet having an exposed surface of the first polarity, at least one pocket fitted with a third ferromagnetic disc, and at least one locating pin; and
wherein a lower surface of a building block of the plurality of building blocks magnetically attaches onto an upper surface of a building block of the plurality of building blocks or onto an upper surface of a base block of the plurality of base blocks.

2. The construction kit of claim 1, wherein the plurality of building blocks, the plurality of base blocks and the plurality of finishing blocks each include a variety of shapes.

3. The construction kit of claim 1, wherein each magnet is substantially flush with a surface of a block.

4. The construction kit of claim 1, wherein each magnet protrudes from a surface of a block.

5. The construction kit of claim 1, wherein
a base block has an upper surface fitted with plurality of magnets having a first series of polarization at the upper surface; and
a building block has a lower surface fitted with plurality of magnets having a second series of polarization at the lower surface, the second series being opposite to and attracted with the first series.

6. The construction kit of claim 1, wherein
a base block has a plurality of locating pins at an upper surface; and
a building block has a plurality of locating holes a lower surface,
wherein the plurality of locating pins fit into the plurality of locating pins to perfect alignment of the base block with the building block and increase sturdiness of a structure.

7. The construction kit of claim 1, wherein the locating hole is a pocket or recess in a surface.

8. The construction kit of claim 1, wherein the locating pin is a stud.

9. The construction kit of claim 1, wherein the plurality of building blocks includes a rod with detachable ends.

10. The construction kit of claim 1, further comprising:
a plurality of finishing blocks, each finishing block having a fourth ferromagnetic disc,
wherein a lower surface of a finishing block of the plurality of finishing blocks magnetically attaches onto an upper surface of a building block of the plurality of building blocks or onto an upper surface of a base block of the plurality of base blocks.

11. The construction kit of claim 1, wherein a ferromagnetic structure is attached to the base block or the building block.

12. The construction kit of claim 11, wherein the ferromagnetic structure is a plate.

13. A construction kit, comprising:
a plurality of base blocks, each base block having a stud; and
a plurality of connecting rods, each connecting rod having
a body,
a magnetic connector positioned at a first end of the body, and
a mechanical connector positioned at a second end of the body for engaging the stud, and
wherein at least one of the magnetic connector and the mechanical connector are releasably connectable to the body.

14. The construction kit of claim 13, wherein some of the plurality of connecting rods are Z-shaped.

15. The construction kit of claim 13, wherein a base block includes channel magnets arranged in channels of the base block.

16. The construction kit of claim 13, wherein a base block includes a ferromagnetic structure.

17. The construction kit of claim 13, wherein a connecting rod is Y-shaped, H-shaped, X-shaped, U-shaped, V-shaped or any other shape.

18. The construction kit of claim 13, the mechanical connector further including an embedded magnet that magnetically couples to the stud.

19. The construction kit of claim 18, the embedded magnet comprising a first embedded magnet, and the each base block further comprising a second embedded magnet proximate the stud that magnetically couples to the first embedded magnet.

20. The construction kit of claim 18, the each base block further comprising a ferromagnetic structure proximate to the stud that magnetically couples to the embedded magnet of the mechanical connector.
